(19) United States
(12) Patent Application Publication
(10) Pub. No.: US 2008/0135805 A1
(43) Pub. Date: Jun. 12, 2008

(54) Fluorescent Pigments for Coating Compositions

(76) Inventors: Fabienne Cuesta, Waldighoffen (FR); Ted Deisenroth, Brookfield, CA (US); Kamalesh Pai Fondekar, Thane (West) (IN); Ramachandra V. Joshi, Thane (West) (IN); Peter Rohringer, Schonenbuch (CH); Uma Ganeshram, Vashi Navi Mumbai (IN); Josef Zelger, Riehen (CH)

Correspondence Address: JoAnn Villamizar;Ciba Corporation/Patent Department, 540 White Plains Road, P.O. Box 2005, Tarrytown, NY, 10591, US

(21) Appl. No.: 11/659,646

(22) PCT Filed: Aug. 3, 2005
(86) PCT No.: PCT/EP05/53789

§ 371 Date: Oct. 17, 2007

(30) Foreign Application Priority Data
Aug. 12, 2004 (EP) 04103884.5

(51) Int. Cl. C09K 11/06

(52) U.S. Cl. 252/301.25; 252/301.21; 252/301.29; 252/301.28; 252/301.27; 252/301.32; 252/301.26

(57) ABSTRACT

The invention relates to a fluorescent pigment comprising a) a melamine-formaldehyde polycondensation product, b) a distyryl biphenyl fluorescent whitening agent (FWA) of the formula (1), in which R₁ represents hydrogen, chlorine or C₁-C₄alkoxy and M represents hydrogen, an alkaline or alkaline earth metal, ammonium or ammonium that is mono-, di-, tri- or tetrasubstituted by C₁-C₄alkyl or C₂-C₄hydroxyalkyl and, optionally, c) at least one additional fluorescent whitening agent, a process for its preparation and use thereof for the fluorescent whitening of paper, especially in coating.

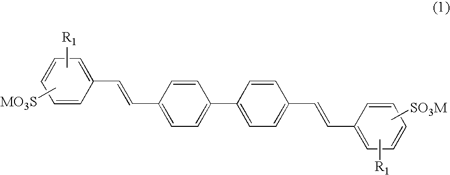

The present invention relates to novel fluorescent pigments obtained by treatment of a melamine-formaldehyde and/or melamine-urea polycondensate with a distyryl biphenyl fluorescent whitening agent (FWA) and, optionally, at least one additional FWA, a process for preparation of the whitening pigments and their use for the fluorescent whitening of paper, especially in coating.

Aqueous coating compositions are used extensively in the production of coated papers and cardboards. For the purpose of whitening, the coating compositions generally comprise anionic fluorescent whitening agents, the action of which is highly dependent on the amount and nature of co-binders used. The use of such anionic fluorescent whitening agents in cationic coating compositions, for example for ink-jet papers, results in a loss of primary effect and poor fastness to light. Bleeding can also be a problem for water-soluble fluorescent whitening agents, particularly in paper and board intended for use in food packaging.

One approach to solving such problems has been disclosed in WO 01/11140 A1, whereby mechanical mixtures of melamine-formaldehyde or phenol-formaldehyde polycondensation products together with water-soluble fluorescent whitening agents are used as whitening pigments for coating compositions. However, such mixtures suffer from the disadvantage that only minor quantities of fluorescent whitening agents are incorporated into large amounts of the polycondensate, thus leading to difficulties in dosage and resulting in large quantities of the polycondensate being present in the coating composition, which may be undesirable.

Surprisingly, it has now been found that coating compositions possessing superior properties, especially with regard to light fastness, bleed fastness and also whitening effect, result by the incorporation of a whitening pigment resulting from treatment of a melamine-formaldehyde polycondensate with a distyryl biphenyl fluorescent whitening agent and, optionally, at least one additional FWA, since the fluorescent whitener is protected from environmental influences.

Accordingly, the present invention relates to a fluorescent pigment comprising
a) a melamine-formaldehyde polycondensation product,
b) a distyryl biphenyl fluorescent whitening agent (FWA) of the formula

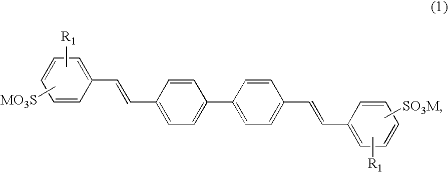

in which
R₁ represents hydrogen, chlorine or C₁-C₄alkoxy and
M represents hydrogen, an alkaline or alkaline earth metal, ammonium or ammonium that is mono-, di-, tri- or tetrasubstituted by C₁-C₄alkyl or C₂-C₄hydroxyalkyl and, optionally,
c) at least one additional fluorescent whitening agent.

Polycondensation products of melamine and formaldehyde, component a) of the composition, also referred to as melamine-formaldehyde (MF) resins, are aminoplastic resins.

The said condensation products are prepared by acid- or base-catalysed reaction of melamine in a methylolation reaction with aqueous formaldehyde solutions to form N-methylol compounds. On extending the reaction time or increasing the temperature, the methylol groups then react with further melamine, forming methylene bridges or, when methylol groups react with one another, methylol ether bridges.

The reaction is usually halted at the stage where preliminary condensation products, which are still soluble or meltable, are present, in order for fillers to be added if desired. To improve the solubility of those preliminary condensation products, some of the methylol groups still remaining may, in addition, be etherified.

Etherification of the N-methylol compounds may also be carried out after azeotropically distilling off the water with alcohols or glycols, or by spray-drying, by etherifying the practically water-free methylol-melamines with lower alcohols or glycols, with the addition of acid or alkaline catalysts, neutralising after etherification and, where appropriate, distilling off the excess alcohol or glycol.

Most preferred resins are tri- or penta-methylolmelamines which may be etherified with, for example, methanol or methanol/diethylene glycol mixtures.

Preferred distyryl biphenyl fluorescent whitening agents, component b) of the composition, are those selected from the compounds of formulae

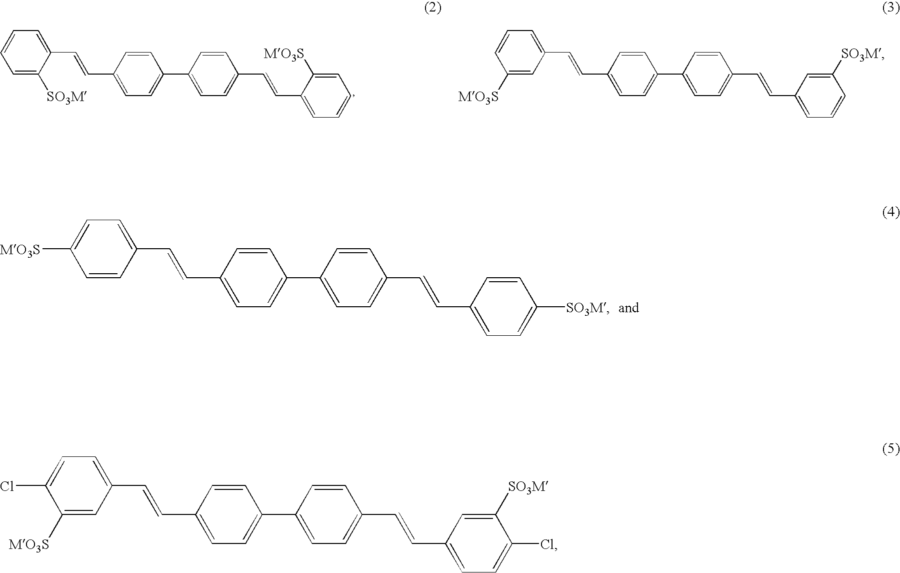

in which
M′ represents hydrogen, lithium, potassium or sodium, whereby the 2,2′-disulphonic acid derivatives of formula (2) are most preferred.

Where a further FWA, component c) of the composition, is present, this may be selected from a wide range of known compounds. Thus, for example, the additional fluorescent whitening agent, component c), is preferably selected from the compounds of formulae (6) to (18), i.e. a bis-triazinylamino stilbene of the formula

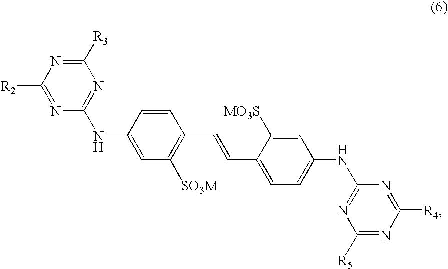

in which
R₂, R₃, R₄ and R₅ each, independently, represent —NH₂, —OC₁-C₄alkyl, -Oaryl, —NHC₁-C₄alkyl, —N(C₁-C₄alkyl)₂, —N(C₁-C₄alkyl)(C₁-C₄hydroxyalkyl), —N(C₁-C₄hydroxyalkyl)₂, or —NHaryl, whereby aryl is phenyl, which may be unsubstituted or substituted by one or two sulphonic acid groups, —COOH, —COOC₁-C₄alkyl, —CONH₂, —CONHC₁-C₄alkyl or by —CON(C₁-C₄alkyl)₂, a morpholino, piperidino or pyrrolidino residue, —SC₁-C₄alkyl or aryl, or an amino acid or amino acid amide residue from which a hydrogen atom has been abstracted from the amino group and
M is as previously defined;
   a 4,4′-bis-(triazol-2-yl)stilbene-2,2′-disulphonic acid of the formula

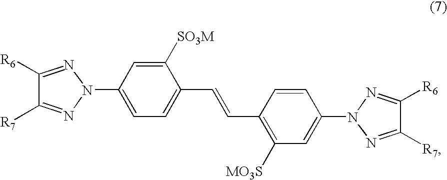

in which
R₆ and R₇ each, independently, represent hydrogen, C₁-C₄alkyl, phenyl or a phenyl sulphonic acid residue and
M is as previously defined;
a 4,4′-distyryl-biphenyl or 4,4′-distyryl-phenyl fluorescent whitening agent of the formula

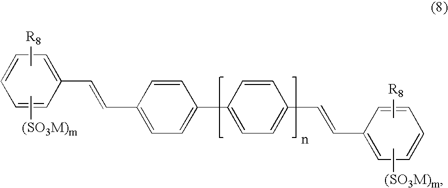

in which
R₈ represents hydrogen, —SO₃M, —OC₁-C₄alkyl, —CN, —Cl, —COOC₁-C₄alkyl, —CON(C₁-C₄alkyl)₂ or —O(CH₂)₃N⁺(CH₃)₂An⁻,
m is 0 or 1,
n is 0 or 1,
M is as previously defined and
An⁻ is an anion of an organic or inorganic acid or a mixture thereof;
   a 4,4′-bis-benzofuran-2-yl-biphenyl compound of the formula

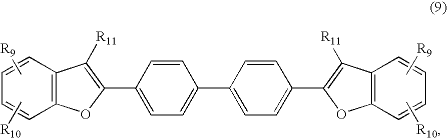

in which
R₉ and R₁₀ each, independently, represent hydrogen, C₁-C₄alkyl, —SO₃M, —Cl or —OC₁-C₄alkyl and
R₁₁ represents hydrogen, C₁-C₄alkyl, —Cl or —SO₃M, whereby
M is as previously defined;
   a 4-phenyl-4′-benzoxazol-2-yl-stilbene of the formula

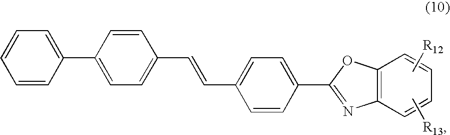

in which
R₁₂ and R₁₃, independently, are hydrogen, C₁-C₄alkyl, —Cl or —SO₃M and
M is as previously defined;
a stilbenzyl-naphthotriazole of the formula

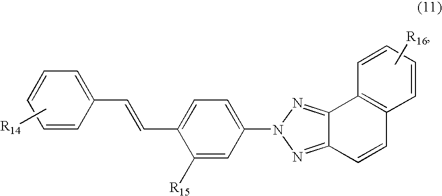

in which
R₁₄ is hydrogen or chlorine,
R₁₅ is —SO₃M, —SO₂N(C₁-C₄alkyl)₂, —SO₂O-phenyl or —CN,
R₁₆ is hydrogen or —SO₃M and
M is as previously defined;
a bis-(benzoxazol-2-yl) derivative of the formula

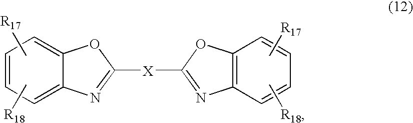

in which each of
R₁₇ and R₁₈, independently, represent hydrogen, C₁-C₄alkyl, —C(CH₃)₂phenyl or —COOC₁-C₄alkyl and
X is —CH═CH— or a residue of the formula

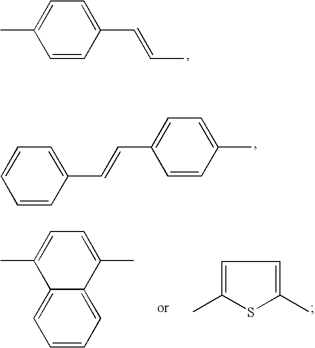

a bis-(benzimidazol-2-yl) derivative of the formula

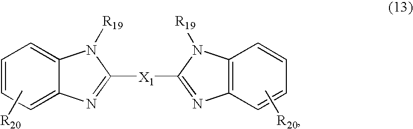

in which each
R₁₉, independently, represents hydrogen, C₁-C₄alkyl or —CH₂CH₂OH,
R₂₀ is hydrogen or —SO₃M,
X₁ is —CH═CH— or a 2,5-furanyl residue and
M is as previously defined;
a coumarin derivative of the formula

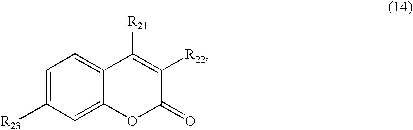

in which
R₂₁ is hydrogen, C₁-C₄alkyl, chlorine or —CH₂CO₂H,
R₂₂ is hydrogen, phenyl, —CO₂C₁-C₄alkyl or a group of the formula

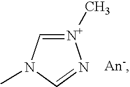

in which
An⁻ is an anion of an organic or inorganic acid or a mixture thereof,
R₂₃ is —OC₁-C₄alkyl, —N(C₁-C₄alkyl)₂, —NHCOC₁-C₄alkyl or a group of the formula

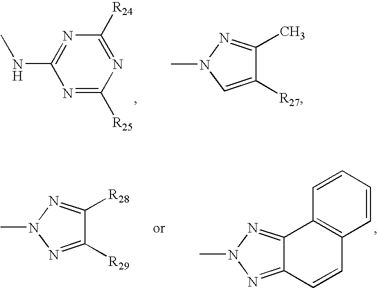

in which each
R₂₄ and R₂₅, independently, represent phenyl, mono- or disulphonated phenyl, phenylamino, mono- or disulphonated phenylamino, morpholino, —N(CH₂CH₂OH), —N(CH₃)(CH₂CH₂OH), —NH₂, —N(C₁-C₄alkyl)₂, —OCH₃, —Cl, —NHCH₂CH₂SO₃H or —NHCH₂CH₂OH,
R₂₇ is hydrogen, C₁-C₄alkyl or phenyl, and each
R₂₈ and R₂₉, independently, represent hydrogen, C₁-C₄alkyl, phenyl or monosulphonated phenyl;
a pyrazoline derivative of the formula

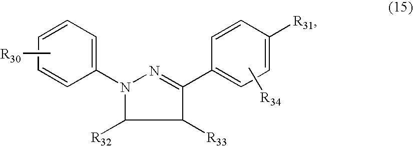

in which
R₃₀ is hydrogen, chlorine or —N(C₁-C₄alkyl)₂
R₃₁ is hydrogen, chlorine, —SO₃M, —SO₂NH₂, —SO₂NH(C₁-C₄alkyl), —CO₂C₁-C₄alkyl, —SO₂C₁-C₄alkyl, —SO₂NHCH₂CH₂CH₂N⁺(CH₃)₃An⁻ or —SO₂NHCH₂CH₂CH₂NH⁺(C₁-C₄alkyl)₂An⁻,
R₃₂ and R₃₃ are the same or different and each is hydrogen, C₁-C₄alkyl or phenyl,
R₃₄ is hydrogen or chlorine,
An⁻ is an anion of an organic or inorganic acid and
M is as previously defined;
   a naphthalimide derivative of the formula

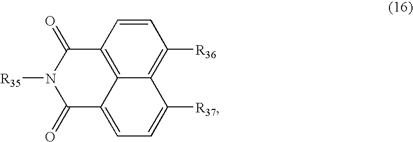

in which
R₃₅ is C₁-C₄alkyl or —CH₂CH₂CH₂N⁺(CH₃)₃An⁻, in which An⁻ is an anion of an organic or inorganic acid, each
R₃₆ and R₃₇, independently, are —OC₁-C₄alkyl, —SO₃M or —NHCOC₁-C₄alkyl and
M is as previously defined;
   a benzimidazol-2-yl benzofuran derivative of the formula

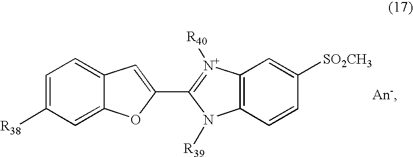

in which
R₃₈ is C₁-C₄alkoxy, each
R₃₉ and R₄₀, independently, is C₁-C₄alkyl or benzyl and
An⁻ is an anion of an organic or inorganic acid;
a 2-styrylbenzoxazole or 2-styrylnaphthoxazole of the formula

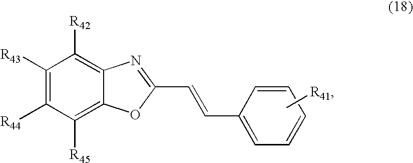

in which
R₄₁ is —CN, chlorine, —CO₂C₁-C₄alkyl or phenyl,
R₄₂ and R₄₃ are the atoms required to form a fused benzene ring or each
R₄₃ and R₄₅, independently, are hydrogen or C₁-C₄alkyl and
R₄₄ is hydrogen, C₁-C₄alkyl or phenyl and
a fluorescent whitening agent that is a pyrenyl-1,3,5-triazine, in addition to
mixtures of such fluorescent whitening agents.

Of the compounds of classes (6) to (18), most suitable for use as component c) of the composition are those bis-triazinylaminostilbene disulphonic acids of the formula (6) in which R₂ and R₄ are identical and R₃ and R₅ are identical and are each independently represent —NH₂, —NHC₁-C₄alkyl, —N(C₁-C₄alkyl)₂, —N(C₁-C₄alkyl)(C₂-C₄hydroxyalkyl), —N(C₂-C₄ hydroxyalkyl)₂, —NHaryl, in which aryl is unsubstituted phenyl or phenyl which is substituted by one or two —SO₃M groups, a morpholino residue or an amino acid or amide residue from which a hydrogen atom has been abstracted from the amino group.

Preferred amino acid or amino acid amide residue from which a hydrogen atom has been removed are those derived from glycine, alanine, serine, cysteine, phenylalanine, tyrosine (4-hydroxyphenylalanine), diiodotyrosine, tryptophan (β-indolylalanine), histidine ((β-imidazolylalanine), α-aminobutyric acid, methionine, valine (α-aminoisovaleric acid), norvaline, leucine (α-aminoisocaproic acid), isoleucine (α-amino-β-methylvaleric acid), norleucine (α-amino-n-caproic acid), arginine, ornithine (α,δ-diaminovaleric acid), lysine (α,ε-diaminocaproic acid), aspartic acid (aminosuccinic acid), glutamic acid (α-aminoglutaric acid), threonine, hydroxyglutamic acid and taurine, as well as mixtures and optical isomers thereof, glycine and aspartic acid being especially preferred.

A further preferred example of an amino acid from which an amino acid residue may be derived is iminodiacetic acid or the mono- or diacid amide thereof, whilst a suitable amino acid amide is 2-hydroxyethylaminopropionamide.

Most especially preferred fluorescent pigments of the invention are those comprising
a) a pentamethylol-melamine, for example, LYOFIX® CHN,
b) a distyryl biphenyl fluorescent whitening agent of formula (2) in which M′ is as defined previously and
c) a bis-triazinylaminostilbene disulphonic acid of the formula (6) in which R₂ and R₄ are identical and both represent an anilino or an anilino mono- or disulphonic acid residue or a morpholino residue and R₃ and R₅ are identical and both represent —NH₂, a 2-hydroxyethylaminopropionamide residue, a mono- or di-(2-hydroxyethyl)amino residue or an aspartic acid residue and M is hydrogen or sodium.

Since, however, the additional FWA component c) of the fluorescent pigment is optional, a further preferred pigment may also comprise
a) a pentamethylol-melamine, for example, LYOFIX® CHN and
b) a distyryl biphenyl fluorescent whitening agent of formula (2) in which M′ is as defined previously.

Within the scope of the definitions of the substituents in the compounds of formulae (1) to (18), C₁-C₄alkyl radicals are branched or unbranched and are, for example, methyl, ethyl, propyl, isopropyl or n- sec- or tert-butyl; they may be unsubstituted or substituted by halogen, for example fluorine, chlorine or bromine. C₁-C₄Alkoxy is, for example, methoxy, ethoxy, propoxy, isopropoxy or n-butoxy whilst C₂-C₄hydroxyalkyl may, for example, be hydroxyethyl, hydroxypropyl or hydroxybutyl.

The anionic radical An⁻ as an anion of an organic or inorganic may be selected from the group consisting of halide, e.g. chloride, bromide or iodide, sulphate, methyl sulphate, boron tetrafluoride, aminosulphonate, perchlorate, carbonate, bicarbonate, phosphate, phosphoromolybdate, phosphorotungstate, phosphorotungstomolybdate, benzenesulphonate, naphthalenesulphonate, 4-chloro-benzenesulphonate, oxalate, maleate, acetate, propionate, lactate, succinate, chloroacetate, tartrate, methanesulphonate or benzoate. Preferable examples of such anions are chloride, hydrogensulphate, sulphate, methosulphate, phosphate, formate, lactate or acetate, especially chloride and methosulphate. The anion can be exchanged in a known manner for another anion.

The ratios of the FWA components b) and c) of the fluorescent pigments may vary over wide ranges depending on the requirements of the final product. Since component c) of the fluorescent pigment is optional, this may comprise from 0 to 90% by weight, based on the total weight of fluorescent whitening agents present in the pigment, of the fluorescent whitening agent, component c) of the composition.

However, when the additional FWA, component c) of the fluorescent pigment is present, this may comprise from 5 to 90%, preferably from 10 to 80% and, most preferably, from 30 to 70%, by weight, based on the total weight of fluorescent whitening agents present in the pigment, of the composition.

Similarly, the total amount of FWA present in the fluorescent pigment may vary over a large range, depending on the degree of whiteness required. Thus, the fluorescent pigment of the invention may comprise a total weight of from 0.2 to 25%, preferably from 0.5 to 20% and, most preferably, from 2.0 to 15%, by weight, based on the total weight of fluorescent pigment, of the fluorescent whitening agents, components b) and, optionally, c) of the composition.

A further aspect of the invention is a process for the preparation of the fluorescent pigments of the invention, whereby the melamine-formaldehyde polycondensation product is reacted with a fluorescent whitening agent of formula (1) and, optionally, at least one further fluorescent whitening agent, component c), in aqueous medium, in the presence of mineral acid, and subsequently treated with base.

More specifically, the fluorescent pigments of the invention may be prepared by addition of the compound of formula (1) and, optionally, at least one further fluorescent whitening agent, component c), to an excess of the melamine-formaldehyde polycondensate in aqueous media under acidic conditions resulting from the addition of strong mineral acid, for example, concentrated hydrochloric acid. The mixture is then stirred, preferably at elevated temperature, for example, at between 50 and 90° C., preferably 65 to 75° C. until reaction is complete and, subsequently, basifying the reaction mixture with strong inorganic base, for example, an alkali metal hydroxide such as sodium hydroxide. The resulting aqueous suspension may be used directly in the coating colour or, preferably, is filtered, the resulting whitening pigment dried and then ground to a suitable particle size.

The fluorescent whitening agents of formulae (1) to (18) are known compounds or may be obtained by known procedures.

The finely particulate whitened whitening pigments can, after dry-grinding, be incorporated in powder form directly in the paper coating composition, the particle size being from 0.05 to 40 μm, preferably from 0.3 to 10 μm and especially from 0.5 to 5 μm.

In most instances, however, it will probably be more convenient to disperse the finely particulate whitening pigments in an aqueous phase and to incorporate the resulting aqueous dispersion in the paper coating compositions.

The amount of whitening pigments for use according to the invention employed in the paper coating composition depends on the desired whitening effect; it is usually from 0.01 to 5% by weight of pure active substance, based on the melamine-formaldehyde polycondensation product used.

The paper coating compositions generally have a solids content of from 35 to 80% by weight, preferably from 40 to 70% by weight. In addition to 0.01 to 10 parts by weight of the fluorescent pigment of the invention, they generally comprise, per 100 parts of inorganic pigment,
(i) from 3 to 25 parts by weight of binder and co-binder,
(ii) 0 to 1 part by weight of rheology modifier,
(iii) 0 to 2 parts by weight of wet-strength agent and
(iv) 0 to 5 parts by weight of a further fluorescent whitening agent.

The whitening pigments according to the invention are excellently suitable for whitening the optionally pigmented coating compositions customarily used in the textile, paint, adhesives, plastics, wood and paper industries. Such coating compositions comprise, as binders (co-binders), plastics dispersions based on copolymers of butadiene and styrene, of naphthalene sulphonic acids and formaldehyde, of polyethylene and polypropylene oxides, of acrylonitrile, butadiene and styrene, of acrylic acid esters, of ethylene and vinyl chloride and of ethylene and vinyl acetate, or homopolymers, such as polyvinyl chloride, polyvinylidene chloride, polyethylene, polyvinyl acetate, polyvinyl alcohol, or polyurethane.

If desirable, the coating composition may, in addition to the fluorescent pigment, contain further fluorescent whitening agents, whereby these may also be selected from the compounds of formulae (1) to (18).

For the purpose of pigmenting the coating compositions there are generally employed aluminium silicates, such as China clay or kaolin, and also barium sulphate, satin white, titanium dioxide or calcium compounds for paper. These are described by way of example in J. P. Casey “Pulp and Paper; Chemistry and Chemical Technology”, 2nd Ed. Vol. III; p. 1648-1649 and in Mc Graw-Hill “Pulp and Paper Manufacture”, 2^{nd} Ed. Vol. II, p. 497 and in EP-A-0 003 568.

The whitening pigments according to the invention may be used especially for the coating of paper, more especially ink-jet and photographic paper, wood, foils, textiles, non-woven materials and suitable building materials. Special preference is given to use on paper and cardboard and on photographic and ink-jet papers.

Consequently, a further aspect of the invention is paper, which has been treated with a coating composition as described above.

The coatings or coverings so obtained have, in addition to a high degree of fastness to light, an excellent degree of whiteness. Evenness, smoothness, volume and printability properties are also improved because the whitening pigments used in accordance with the invention remain in the paper matrix as additional filler and have a favourable effect on the printability of the paper. Furthermore, due to their excellent bleed-fastness, such coatings are eminently suitable for use in food packaging.

The following Examples illustrate the invention, without intending to be restrictive in nature; parts and percentages are by weight unless otherwise stated.

### A. Preparation of Whitening Pigments

### EXAMPLE 1

To a solution of 84 g of a 59.7% aqueous pentamethylol-melamine (LYOFIX™ CHN) and 300 ml of water, are added 5.2 g of an aqueous slurry containing 30% of the compound of formula

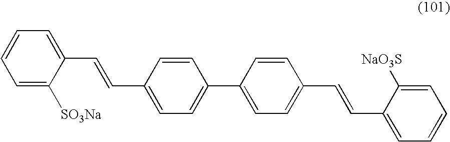

and the mixture stirred until a homogenous solution is obtained. The pH of the solution is adjusted to 3.9 by addition of 37% aqueous hydrochloric acid and heated to 70° C. with stirring. Further hydrochloric acid is then added to adjust the pH to 2.0 and the solution stirred for 4 hours at 70° C. After cooling to room temperature, the pH is adjusted to 9.5-10.0 by addition of 32% aqueous sodium hydroxide solution and the mixture stirred for a further 30 minutes. The precipitated solids are filtered, washed thoroughly with water and dried at 80° C. for 16 hours. There are obtained 32.7 g of a white solid polymeric material incorporating 4.8% of the compound of formula (101).

### EXAMPLE 2

By following the procedure described in Example 1, but replacing the 5.2 g of the slurry of compound (101) by a mixture consisting of 4.17 g of an aqueous slurry containing 30% of the compound of formula (101) and 0.31 g of the compound of formula

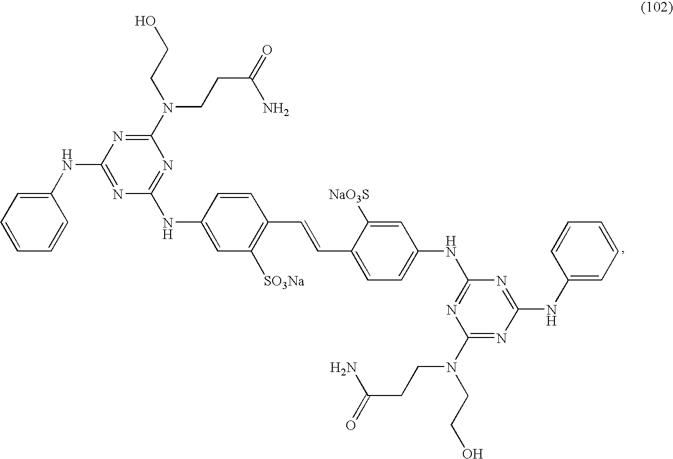

there are obtained 31 g of a white solid incorporating 4.0% of the compound of formula (101) and 1.0% of the compound of formula (102).

### EXAMPLE 3

By following the procedure of Example 2, but replacing the 0.31 g of the compound of formula (102) by 0.31 g of the compound of formula

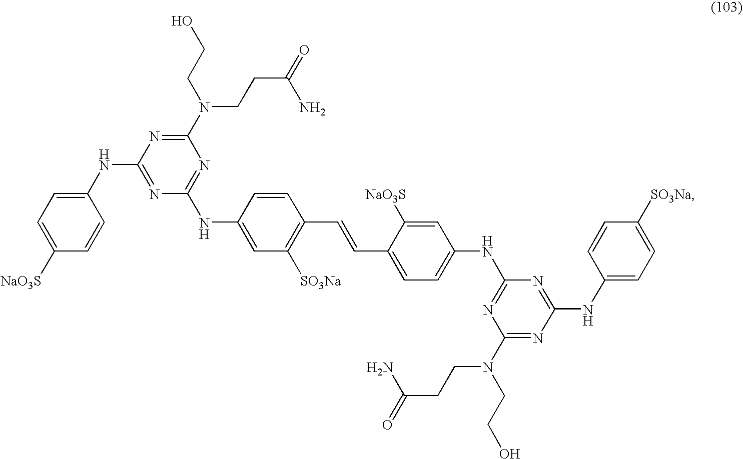

there are obtained 29.9 g of a white solid incorporating 4.2% of the compound of formula (101) and 1.0% of the compound of formula (103).

### EXAMPLE 4

By following the procedure of Example 2, but replacing the 0.31 g of the compound of formula (102) by 0.31 g of the compound of formula

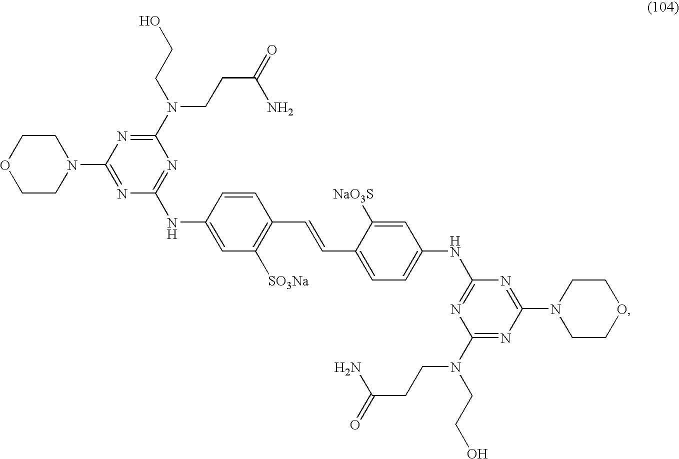

there are obtained 29.9 g of a white solid incorporating 4.1% of the compound of formula (101) and 1.0% of the compound of formula (104).

### EXAMPLE 5

To a solution of 150.7 g of a 59.7% aqueous pentamethylol-melamine (LYOFIX™ CHN) and 525.8 g of water, are added 16.7 g of an aqueous slurry containing 29.9% of the compound of formula (101) and 16.5 g of an aqueous slurry containing 30.3% of the compound of formula

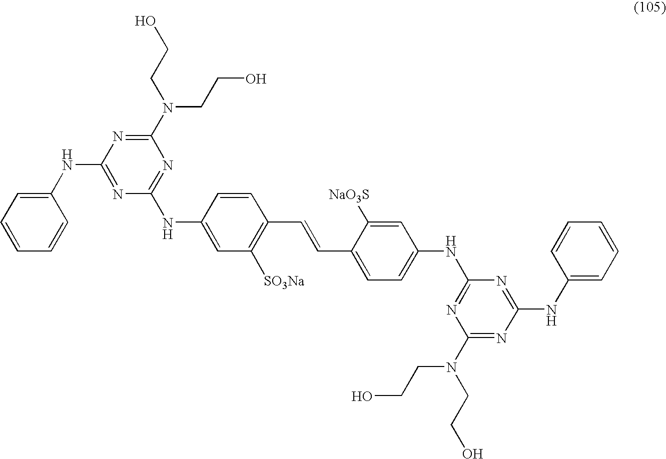

and the mixture stirred until a homogenous solution is obtained. The pH of the solution is adjusted to 3.9 by addition of 37% aqueous hydrochloric acid and heated to 72° C. with stirring. After stirring for 2 hours, further hydrochloric acid is added to adjust the pH to 2.2, the solution stirred for 2 hours, again treated with hydrochloric acid to lower the pH to 1.4 and stirring continued for a further 2 hours at 72° C. After cooling to room temperature, the pH is adjusted to 9.5-10.0 by addition of 32% aqueous sodium hydroxide solution and the mixture stirred for a further 30 minutes. The precipitated solids are filtered, washed thoroughly with water and dried at under vacuum at 80° C. There are obtained 56.5 g of a white solid polymeric material incorporating 8.8% of the compound of formula (101) and 8.8% of the compound of formula (105).

### EXAMPLE 6

By following the procedure described in Example 5, but replacing the 16.5 g of the slurry of compound (105) by 32.2 g of an aqueous solution containing 15.5% of the compound of formula

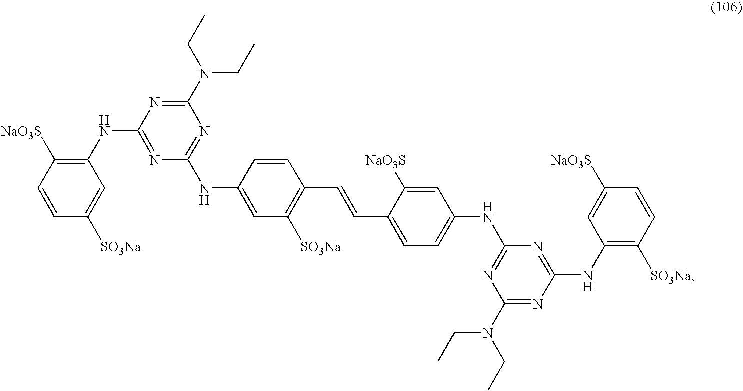

there are obtained 61.2 g of a white solid incorporating 8% of the compound of formula (101) and 8% of the compound of formula (106).

### EXAMPLE 7

By following the procedure described in Example 5, but replacing the 16.5 g of the slurry of compound (105) by 32.2 g of an aqueous solution containing 15.5% of the compound of formula

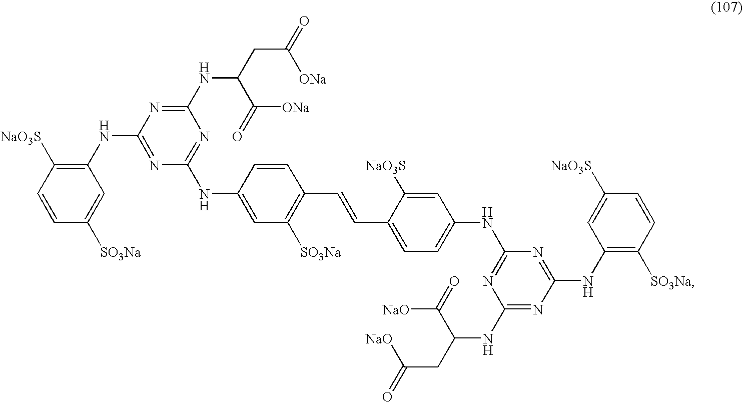

there are obtained 56.8 g of a white solid incorporating 8.8% of the compound of formula (101) and 8.8% of the compound of formula (107).

### EXAMPLE 8

By following the procedure described in Example 5, but replacing the 16.5 g of the slurry of compound (105) by 22.0 g of an aqueous solution containing 22.8% of the compound of formula

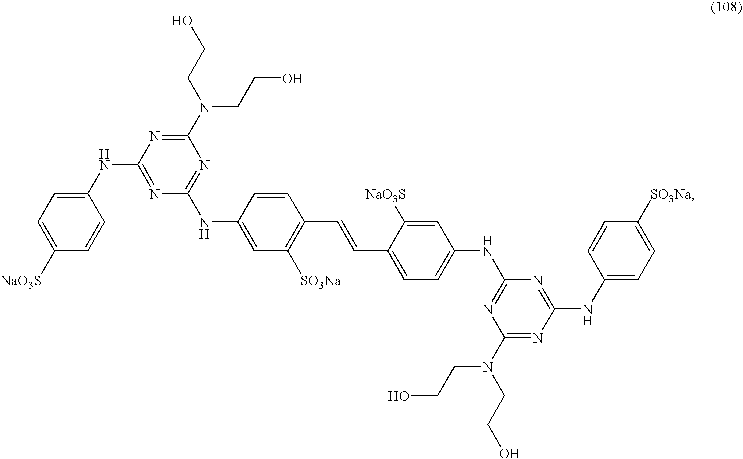

there are obtained 68.9 g of a white solid incorporating 7.2% of the compound of formula (101) and 7.2% of the compound of formula (108).

### EXAMPLE 9

By following the procedure described in Example 5, but employing 10.0 g of an aqueous slurry containing 29.9% of the compound of formula (101) and replacing the 16.5 g of the slurry of compound (105) by 8.2 g of the compound of formula

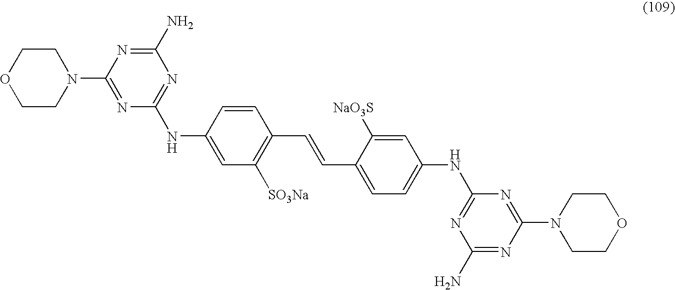

having an active content of 85.8%, there are obtained 61.4 g of a white solid incorporating 4.9% of the compound of formula (101) and 11.5% of the compound of formula (109).

### EXAMPLE 10

By following the procedure described in Example 5, but employing 23.4 g of an aqueous slurry containing 29.9% of the compound of formula (101) and replacing the 16.5 g of the slurry of compound (105) by 3.5 g of the compound of formula (109) having an active content of 85.8%, there are obtained 68.9 g of a white solid incorporating 10% of the compound of formula (101) and 4.3% of the compound of formula (109).

### EXAMPLE 11

To a solution of 301.5 g of 59.7% aqueous pentamethylol-melamine (LYOFIX™ CHN) and 1109 g of water, are added 67.6 g of an aqueous slurry containing 18.9% of the compound of formula (101) and 11.1% of the compound of formula (109). The solution is stirred and the pH adjusted to 3.9 by addition of 37% aqueous hydrochloric acid. The reaction mass is heated to 73° C. and, after adjusting the pH to 2.0 with 37% hydrochloric acid, the mixture is stirred for 2 hours. The pH is then adjusted to 1.5 with 37% hydrochloric acid and stirring continued for a further 2 hours. After cooling to room temperature, 32% aqueous sodium hydroxide solution is added to pH 9.5-10.0. The precipitated solids are filtered, washed with water and dried under vacuum at 100° C. There are obtained 113.1 g of a whitening pigment incorporating 11.3% of the compound of formula (101) and 6.6% of the compound of formula (109).

### B. Application Examples

Coating colours having a solids content of 62% and consisting of 100 parts of inorganic pigment (60% calcium carbonate and 40% clay), 0.2 parts (based on the weight of inorganic pigment) of polyvinyl alcohol, 9 parts (based on the weight of inorganic pigment) of SBR latex and 0.25 parts (based on the weight of inorganic pigment) of rheology modifier (Coatex® RT5) are prepared by homogenising the components.

Dispersions of the whitening pigments of Examples 1-11 are prepared by wet milling approximately 20 g of the pigment with glass beads of approximately 2 mm diameter in the presence of a dispersant (e.g. 25 g of a 10% aqueous solution of Pluronic® F 108) in 75 ml of water during approximately 17 hours.

To the coating colour, prepared as described above, sufficient of the whitening pigment dispersions are added to result in a solid content of 4 parts, based on the weight of inorganic pigment, and the mixtures stirred for 10 minutes.

Each of the resulting coating colours is then applied to an FWA-free base paper by means of a draw down rod, such that a coat weight of approximately 12 g/m² results. After drying, the CIE Whiteness and Iso-fluorescence values are recorded using a Datacolor Elrepho 3000 spectrophotometer and are summarized in Table 1 below.

TABLE 1

| Example Nr. | Whitening Pigment | CIE Whiteness | Fluorescence |
|---|---|---|---|
| | None | 74.3 | 0.0 |
| 12 | Example 1 | 114.1 | 13.0 |
| 13 | Example 2 | 109.9 | 11.5 |
| 14 | Example 3 | 111.2 | 12.1 |
| 15 | Example 4 | 110.1 | 11.7 |
| 16 | Example 5 | 105.0 | 10.9 |
| 17 | Example 6 | 108.7 | 12.1 |
| 18 | Example 7 | 111.8 | 13.3 |
| 19 | Example 8 | 109.2 | 12.3 |
| 20 | Example 9 | 106.7 | 11.0 |
| 21 | Example 10 | 112.8 | 13.7 |
| 22 | Example 11 | 106.8 | 11.9 |

In a further series of experiments, the bleed fastness's of the FWA's incorporated into the melamine/formaldehyde polycondensates, towards water, 1.5 g/l aqueous sodium carbonate and 1.5% aqueous acetic acid are measured according to EN 648 and the results summarized in the following Table 2, whereby bleed fastness is measured on a scale of 0-5 (a value of 5 corresponds to zero bleeding).

TABLE 2

| | | Water | | Na₂CO₃ | |
|---|---|---|---|---|---|
| Example | Whitening | for 10 | Water for | for | CH₃COOH |
| Nr. | Pigment | minutes | 24 hours | 24 hours | for 24 hours |
| 23 | Example 1 | 5 | 5 | 4 | 5 |
| 24 | Example 2 | 5 | 5 | 4 | 4 |
| 25 | Example 3 | 5 | 5 | 4 | 5 |
| 26 | Example 4 | 5 | 4 | 3 | 5 |
| 27 | Example 5 | 5 | 3 | 3 | 5 |
| 28 | Example 6 | 5 | 3 | 4 | 4 |
| 29 | Example 7 | 5 | 2 | 4 | 4 |
| 30 | Example 8 | 5 | 2 | 5 | 5 |
| 31 | Example 9 | 4 | 2 | 4 | 4 |
| 32 | Example 10 | 4 | 2 | 4 | 4 |
| 33 | Example 11 | 3 | 1 | 4 | 4 |

As is apparent from the above results, the fluorescent pigments of the invention exhibit excellent whitening effects when applied as coatings to paper and, furthermore, the FWA's incorporated therein mostly exhibit excellent bleed fastness.

1. A fluorescent pigment comprising
a) a melamine-formaldehyde polycondensation product,
b) a distyryl biphenyl fluorescent whitening agent (FWA) of the formula 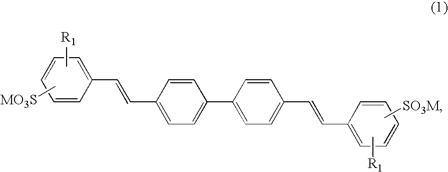
in which
R₁ represents hydrogen, chlorine or C₁-C₄alkoxy and
M represents hydrogen, an alkaline or alkaline earth metal, ammonium or ammonium that is mono-, di-, tri- or tetrasubstituted by C₁-C₄alkyl or C₂-C₄hydroxyalkyl and, optionally,
c) at least one additional fluorescent whitening agent.

2. A fluorescent pigment according to claim 1, in which the distyryl biphenyl FWA, component b), is selected from the compounds of formulae 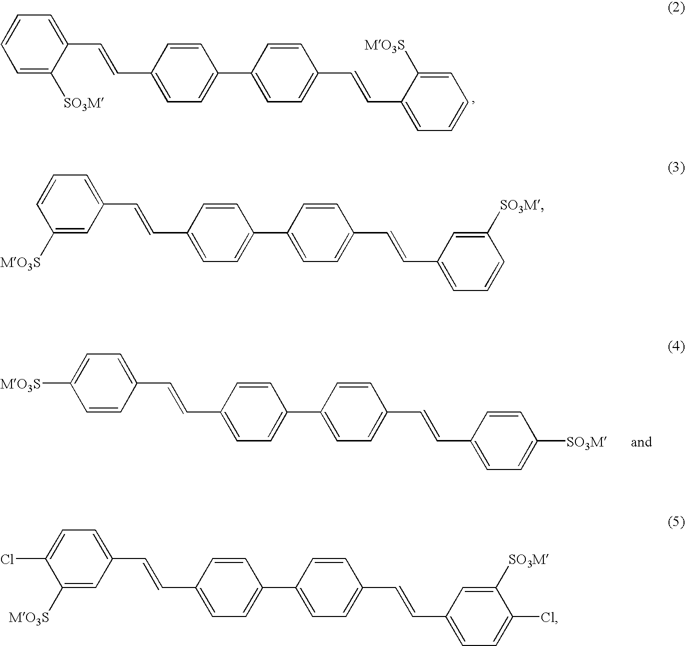
in which
M′ represents hydrogen, lithium, potassium or sodium.

3. A fluorescent pigment according to claim 1, in which the additional fluorescent whitening agent, component c), is selected from the compounds of formulae (6) to (18), i.e. a bis-triazinylamino stilbene of the formula 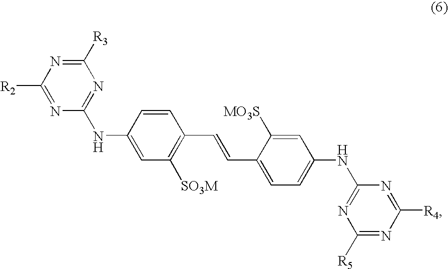
in which
R₂, R₃, R₄ and R₅ each, independently, represent —NH₂, —OC₁-C₄alkyl, -Oaryl, —NHC₁-C₄alkyl, —N(C₁-C₄alkyl)₂, —N(C₁-C₄alkyl)(C₁-C₄hydroxyalkyl), —N(C₁-C₄hydroxyalkyl)₂, or —NHaryl, whereby aryl is phenyl, which may be unsubstituted or substituted by one or two sulphonic acid groups, —COOH, —COOC₁-C₄alkyl, —CONH₂, —CONHC₁-C₄alkyl or by —CON(C₁-C₄alkyl)₂, a morpholino, piperidino or pyrrolidino residue, —SC₁-C₄alkyl or aryl, or an amino acid or amino acid amide residue from which a hydrogen atom has been abstracted from the amino group and
M is as defined in claim 1;
a 4,4′-bis-(triazol-2-yl)stilbene-2,2′-disulphonic acid of the formula 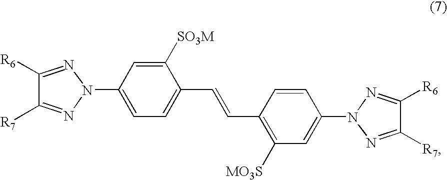
in which
R₆ and R₇ each, independently, represent hydrogen, C₁-C₄alkyl, phenyl or a phenyl sulphonic acid residue and
M is as defined in claim 1;
a 4,4′-distyryl-biphenyl or 4,4′-distyryl-phenyl fluorescent whitening agent of the formula 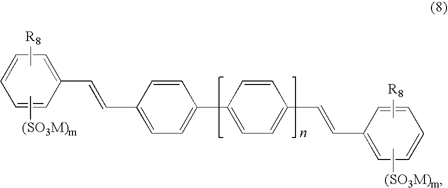
in which
R₈ represents hydrogen, —SO₃M, —OC₁-C₄alkyl, —CN, —Cl, —COOC₁-C₄alkyl, —CON(C₁-C₄-Alkyl)₂ or —O(CH₂)₃N⁺(CH₃)₂An⁻,
m is 0 or 1,
n is 0 or 1,
M is as defined in claim 1 and
An⁻ is an anion of an organic or inorganic acid or a mixture thereof;
a 4,4′-bis-benzofuran-2-yl-biphenyl compound of the formula 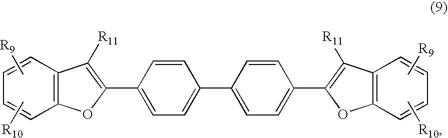
in which
R₉ and R₁₀ each, independently, represent hydrogen, C₁-C₄alkyl, —SO₃M, —Cl or —OC₁-C₄-alkyl and
R₁₁ represents hydrogen, C₁-C₄alkyl, —Cl or —SO₃M, whereby
M is as defined in claim 1;
a 4-phenyl-4′-benzoxazol-2-yl-stilbene of the formula 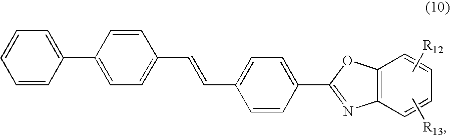
in which
R₁₂ and R₁₃, independently, are hydrogen, C₁-C₄alkyl, —Cl or —SO₃M and
M is as defined in claim 1;
a stilbenzyl-naphthotriazole of the formula 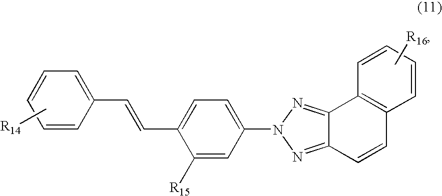
in which
R₁₄ is hydrogen or chlorine,
R₁₅ is —SO₃M, —SO₂N(C₁-C₄alkyl)₂, —SO₂O-phenyl or —CN,
R₁₆ is hydrogen or —SO₃M and
M is as defined in claim 1;
a bis-(benzoxazol-2-yl) derivative of the formula 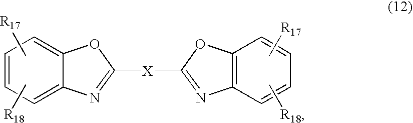
in which each of
R₁₇ and R₁₈, independently, represent hydrogen, C₁-C₄alkyl, —C(CH₃)₂-phenyl or —COOC₁-C₄alkyl and
X is —CH═CH— or a residue of the formula 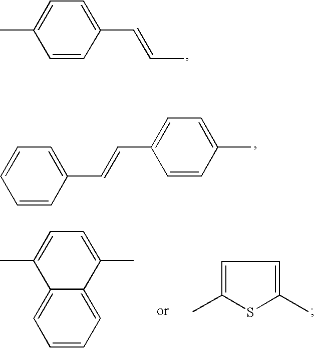
a bis-(benzimidazol-2-yl) derivative of the formula 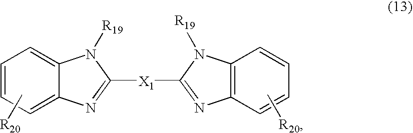
in which each
R₁₉, independently, represents hydrogen, C₁-C₄alkyl or —CH₂CH₂OH,
R₂₀ is hydrogen or —SO₃M,
X₁ is —CH═CH— or a 2,5-furanyl residue and
M is as defined in claim 1;
a coumarin derivative of the formula 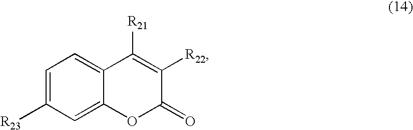
in which
R₂₁ is hydrogen, C₁-C₄alkyl, chlorine or —CH₂CO₂H,
R₂₂ is hydrogen, phenyl, —CO₂C₁-C₄alkyl or a group of the formula 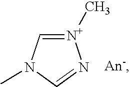
in which
An⁻ is an anion of an organic or inorganic acid or a mixture thereof,
R₂₃ is —OC₁-C₄alkyl, —N(C₁-C₄alkyl)₂, —NHCOC₁-C₄alkyl or a group of the formula 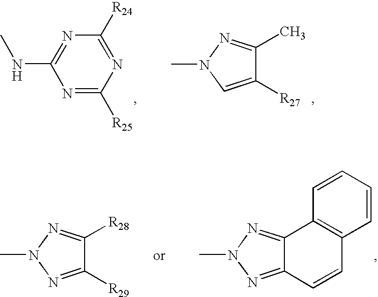
in which each
R₂₄ and R₂₅, independently, represent phenyl, mono- or disulphonated phenyl, phenylamino, mono- or disulphonated phenylamino, morpholino, —N(CH₂CH₂OH), —N(CH₃)(CH₂CH₂OH), —NH₂, —N(C₁-C₄alkyl)₂, —OCH₃, Cl, —NHCH₂CH₂SO₃H or —NHCH₂CH₂OH,
R₂₇ is hydrogen, C₁-C₄alkyl or phenyl, and each
R₂₈ and R₂₉, independently, represent hydrogen, C₁-C₄alkyl, phenyl or monosulphonated phenyl;
a pyrazoline derivative of the formula 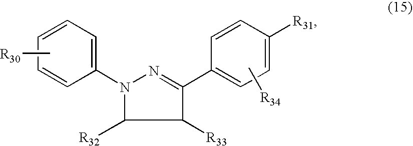
in which
R₃₀ is hydrogen, chlorine or —N(C₁-C₄alkyl)₂
R₃₁ is hydrogen, chlorine, —SO₃M, —SO₂NH₂, —SO₂NH(C₁-C₄alkyl), —CO₂C₁-C₄alkyl, —SO₂C₁-C₄alkyl, —SO₂NHCH₂CH₂CH₂N⁺(CH₃)₃An⁻ or —SO₂NHCH₂CH₂CH₂NH⁺(C₁-C₄alkyl)₂An⁻,
R₃₂ and R₃₃ are the same or different and each is hydrogen, C₁-C₄alkyl or phenyl,
R₃₄ is hydrogen or chlorine,
An⁻ is an anion of an organic or inorganic acid and
M is as defined in claim 1;
a naphthalimide drivative of the formula 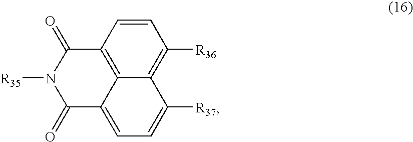
in which
R₃₅ is C₁-C₄alkyl or —CH₂CH₂CH₂N⁺(CH₃)₃An⁻, in which An⁻ is an anion of an organic or inorganic acid, each
R₃₆ and R₃₇, independently, are —OC₁-C₄alkyl, —SO₃M or —NHCOC₁-C₄alkyl and
M is as defined in claim 1;
a benzimidazol-2-yl benzofuran derivative of the formula 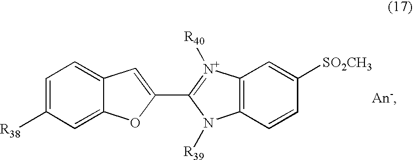
in which
R₃₈ is C₁-C₄alkoxy, each
R₃₉ and R₄₀, independently, is C₁-C₄alkyl or benzyl and
An⁻ is an anion of an organic or inorganic acid;
a 2-styrylbenzoxazole or 2-styrylnaphthoxazole of the formula 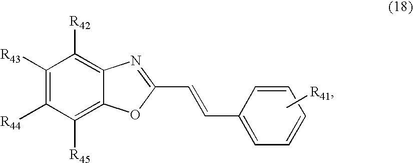
in which
R₄₁ is —CN, chlorine, —CO₂C₁-C₄alkyl or phenyl,
R₄₂ and R₄₃ are the atoms required to form a fused benzene ring or each
R₄₃ and R₄₅, independently, are hydrogen or C₁-C₄alkyl and
R₄₄ is hydrogen, C₁-C₄alkyl or phenyl and
a fluorescent whitening agent that is a pyrenyl-1,3,5-triazine, in addition to mixtures of such fluorescent whitening agents.

4. A fluorescent pigment according to claim 3, in which the additional fluorescent whitening agent, component c) is a compound of formula (6) in which
R₂ and R₄ are identical and
R₃ and R₅ are identical and are each independently represent —NH₂, —NHC₁-C₄alkyl, —N(C₁-C₄alkyl)₂, —N(C₁-C₄alkyl)(C₂-C₄hydroxyalkyl), —N(C₂-C₄hydroxyalkyl)₂, —NHaryl, in which aryl is unsubstituted phenyl or phenyl which is substituted by one or two —SO₃M groups, a morpholino residue or an amino acid or amide residue from which a hydrogen atom has been abstracted from the amino group and
M is as defined in claim 1.

5. A fluorescent pigment according to claim 1, comprising
a) a pentamethylol-melamine,
b) a distyryl biphenyl fluorescent whitening agent of formula (2) in which M′ is hydrogen, lithium, potassium or sodium and
c) a bis-triazinylaminostilbene disulphonic acid of the formula (6) in which R₂ and R₄ are identical and both represent an anilino or an anilino mono- or disulphonic acid residue or a morpholino residue and R₃ and R₅ are identical and both represent —NH₂, a 2-hydroxyethylaminopropionamide residue, a mono- or di-(2-hydroxyethyl)amino residue or an aspartic acid residue and M is hydrogen or sodium.

6. A fluorescent pigment according to claim 1, comprising from 0 to 90% by weight, based on the total weight of fluorescent whitening agents present in the pigment, of the fluorescent whitening agent, component c) of the composition.

7. A fluorescent pigment according to claim 1, comprising from 5 to 90% by weight, based on the total weight of fluorescent whitening agents present in the pigment, of the fluorescent whitening agent, component c) of the composition.

8. A fluorescent pigment according to claim 1, comprising a total weight of from 0.2 to 25% by weight, based on the total weight of fluorescent pigment, of the fluorescent whitening agents, components b) and, optionally, c) of the composition.

9. A process for the preparation of whitening pigment according to claim 1, whereby the melamine-formaldehyde polycondensation product is reacted with a fluorescent whitening agent of formula (1) and, optionally, at least one further fluorescent whitening agent, component c), in aqueous medium, in the presence of mineral acid, and subsequently treated with base.

10. A method of fluorescent whitening of paper by applying to paper the whitening pigment composition, according to claim 1.

11. A paper coating composition comprising, in addition to 0.01 to 10 parts by weight of the whitening pigment according to claim 1, per 100 parts of inorganic pigment,
(i) from 3 to 25 parts by weight of binder and co-binder,
(ii) 0 to 1 part by weight of rheology modifier,
(iii) 0 to 2 parts by weight of wet-strength agent and
(iv) 0 to 5 parts by weight of a further fluorescent whitening agent.

12. A method of fluorescent whitening of paper by applying the paper coating composition according to claim 11 to the paper.

13. Paper which has been treated with fluorescent pigment composition according to claim 1.

14. Paper which has been treated with the paper coating composition according to claim 11.
